(19) United States
(12) Patent Application Publication
(10) Pub. No.: US 2004/0267943 A1
(43) Pub. Date: Dec. 30, 2004

(54) Method of receiving and displaying realtime informations from various information providers including contents information providers and corporate information providers

(75) Inventor: Suk Ho Ryu, Seoul (KR)

Correspondence Address: BACON & THOMAS, PLLC, 625 SLATERS LANE, FOURTH FLOOR, ALEXANDRIA, VA, 22314

(73) Assignee: SHOTECH CORPORATION, San Jose, CA (US)

(21) Appl. No.: 10/874,348

(22) Filed: Jun. 24, 2004

(30) Foreign Application Priority Data
Jun. 25, 2003 (KR) 10-2003-0041585

(51) Int. Cl. G06F 15/16

(52) U.S. Cl. 709/228

(57) ABSTRACT

A method of providing information, which is transmitted from selected content and/or corporation information providers having registered as members, to a user in real time is disclosed. In this method, the content and/or corporation information providers register with a main service system as information providers. The user visits the website of one of the information providers, installs a client module in a user's computer, determines whether reception of information from the information provider is allowed, and transmits and stores information about the user's computer and whether reception of information from the information provider is allowed to and in the main service system. Information is received from the content and/or corporation information providers, and stored in the main service system. Only information from information providers, from which the reception of information is allowed, is transmitted to the user's computer. The transmitted information is displayed on the screen of the user's computer.

### BACKGROUND OF THE INVENTION

1. Field of the Invention

The present invention relates to a method of providing information, which is transmitted from selected content/corporation information providers having registered as members, to a user in real time, which allows the type of advertisement to be selected depending on the type of the user when information, which is received from the information providers and managed by a main service system, and an advertisement are simultaneously displayed on the screen of a user's computer.

2. Description of the Related Art

For methods of obtaining information that a user requires, there are a method of being provided with the information after accessing a corresponding website, and a method of being provided with information via mail, e-mail or facsimile after being registered as a member of a corresponding website. However, when the user is provided with information through these methods, disadvantages arise from the facts that user's personal information is exposed, the user must access a corresponding website whenever the user obtains information, and required information is not provided in real time. Furthermore, when various types of information need to be obtained, the user cannot obtain desired information unless the user visits a plurality of websites that provide the desired information, separately.

To overcome the above-described problems, there was developed an information providing apparatus that allows a user to be provided with various types of information in real time regardless of a web browser. However, this apparatus has a disadvantage in that a user can receives information from a single information provider.

### SUMMARY OF THE INVENTION

Accordingly, the present invention has been made keeping in mind the above problems occurring in the prior art, and an object of the present invention is to provide a method of providing information, which is transmitted from selected content and/or corporation information providers having registered as members, to a user in real time, which allows a client module, which enables the user to receive a variety of necessary information from the content and/or corporation information providers, to be easily installed in a user's computer by one click, and allows the user to select desired information providers from a plurality of content and corporation information providers, without exposing the personal information of the user, such as a residence registration number, an e-mail address, a phone number, an address and an facsimile number.

Another object of the present invention is to provide a method of providing information, which is transmitted from selected content and/or corporation information providers having registered as members, to a user in real time, which allows a user to select the time when the information provided from an information provider is displayed on the screen of a user's computer, from the time when the user's computer is turned on, the time at regular intervals during the turning on of the user's computer, or the time whenever new information arrives.

A further object of the present invention is to provide a method of providing information, which is transmitted from selected content and/or corporation information providers having registered as members, to a user in real time, which allows a user to becomes aware of the information displayed on the screen of a user's computer without the running of a web browser.

Yet another object of the present invention is to provide a method of providing information, which is transmitted from selected content and/or corporation information providers having registered as members, to a user in real time, in which advertisements are classified according to the features of websites, the patterns of information selection and the patterns of advertisement clicking, so that target advertisement can be made suitable for the type of user, and advertisement-related data and statistics can be collected and provided to advertisers.

Still another object of the present invention is to provide a method of providing information, which is transmitted from selected content and/or corporation information providers having registered as members, to a user in real time, which allows information, which is transmitted from the information providers, to be provided to the user without hindrance to the use of a user's computer.

Still another object of the present invention is to provide a method of providing information, which is transmitted from selected content and/or corporation information providers having registered as members, to a user in real time, which additionally provides a function of storing information about a visit to a website and providing information related to the visited website through a separate window at the time when the running of a web browser is terminated or at some other time, a function of separately providing a product comparison window during product search, and/or a function of searching for product information related to an event, such as gift presentation or a discount sale, so that benefit is provided to the user and the efficiency of advertisement is increased.

Still another object of the present invention is to provide a method of providing information, which is transmitted from selected content and/or corporation information providers having registered as members, to a user in real time, in which information providers are classified into content information providers and corporation information providers, so that the roles and authorities of participants, including the user, advertisers and a system operator, can be clearly defined, and subjects related to the provision of information or advertisements, the payment of fees and the distribution of profits are clearly distinguished.

In order to accomplish the above object, the present invention provides a method of providing information, which is transmitted from selected content and/or corporation information providers having registered as members, to a user in real time, including: the information provider registration step of the content and/or corporation information providers registering with a main service system as information providers; the client module installation step of the user visiting websites of some of the information providers having registered as the information providers, installing a client module in a user's computer through the main service system, determining whether reception of information from the information provider is allowed or not, and transmitting and storing information about the user's computer and whether reception of information from the information provider is allowed or not to and in the main service system; the information transmission step of receiving information from the content and/or corporation information providers having registered as the information providers, storing the information, which is transmitted from the content and/or corporation information providers, in the main service system, and transmitting only information, which is transmitted from information providers from which reception of information is allowed, to the user's computer at a point selected by the user; and the information display step of displaying information, which is transmitted from the main service system, on a screen of the user's computer.

The information providers of the information provider registration step may include content information providers capable of providing content information, such as news, stock information, woman information and tour information, and corporation information providers capable of providing corporation information, such as corporation news, official announcements and new product information.

At the information provider registration step, in the website of the information provider, authentication tags for the installation of the client module may be added to a guidance window and an authentication window.

At the information provider registration step, if the corporation information providers pay registration fees, such as annual fees, the main service system may determine the number of time of transmission of information based on the paid fees, and may transmit additional information only when additional fees are paid.

At the client module installation step, when the user's computer accesses a website of one of the information providers having registered as the information providers, the information provider may display a guidance window that includes a description of a client module capable of allowing the user to receive information in real time without leakage of personal information, and an authentication window that allows the user to perform authentication related to installation of the client module.

At the client module installation step, if the user consents to the installation of the client module after viewing the guidance window and the authentication window, the client module may be installed in the user's computer by the main service system, and an icon indicating completion of the installation of the client module may be displayed on a lower part of the screen of the user's computer.

The client module installation step may further include the step of, after the client module has been installed in the user's computer, additionally select an information provider, from which the user can receive information, by visiting a website of another information provider having registered as the information providers or clicking on a banner advertisement displayed on the screen of the user's computer.

At the additional information provider selection step, if the user consents to the additional selection after viewing the guidance window, the information provider may be added to the information provider list of the user's computer, the reception of information from the information provider may be set to be allowed, and related information may be transmitted to the main service system.

At the additional information provider selection step, if the user selects the information provider from which the user can receive information by clicking on an existing icon, the information provider may be added to the information provider list of the user's computer, the reception of information from the information provider may be set to be allowed, and related information may be transmitted to the main service system.

At the additional information provider selection step, the user may receive a list of all the information providers having registered as the information providers from the main service system, select an information provider, which provides information desired by the user, from the list of the all the information providers, and remove an information provider from the list of the all the information providers.

At the additional information provider selection step, if the user selects the information provider by clicking on a banner advertisement of an information display window that displays corporation information including a clause ‘if clicking on this banner, you additionally receives information’, the information provider may be added to the information provider list of the user's computer, the reception of information from the information provider may be set to be allowed, and related information may be transmitted to the main service system.

The client module installation step may further include the step of performing configuration of the client module by the user's clicking on a tray icon of the client module, and the user's adding/deleting an information provider to/from the reception allowance list on the information provider list window that is displayed during the configuration.

Whenever the reception of information from an information provider is set to be allowed or disallowed, related information may be transmitted to the main service system, and the transmitted information may be stored in a per-user information reception allowance DB.

At the information transmission step, advertisement views and clicking information performed by the user on the user's computer may be collected, transmitted to the main service system, and stored in a per-user advertisement clicking pattern DB.

At the information transmission step, information, which will be transmitted by the user, may be classified as periodic or a periodic information, registered manually or automatically in the main service system, and stored in an information DB of the main service system to be prepared for provision to the user in response to a user's request.

At the information transmission step, advertisement-related data, including advertisement image files, advertisement dates, and numbers of advertisement, may be provided from the advertisers respectively, and stored in an advertisement DB of the main service system.

At the information transmission step, the user's computer may transmit a user's unique number to the main service system at a time when the user's computer is turned on or at regular intervals so that it can be determined whether new information exists and the user's computer can receive the new information, together with an advertisement.

The information transmission step may further include the step of the main service system determining a type of the user by analyzing a list of information providers, from which reception of information is allowed, and/or information about clicking of existing advertisements, and transmitting an appropriate type of advertisement or an advertisement modified to fit the type of user to the user according to the type of user.

At the information display step, when the client module of the user's computer receives new information from the main service system, the client module may display an information content window on the screen of the user's computer for each of the information providers.

At the information display step, the information content window may be formed of a title display region displaying a title of information, an information display region displaying contents of information, and an advertisement display region displaying an advertisement image, and an external advertisement display region, which is capable of displaying a special advertisement, such as an image of a moving automobile, is located outside the information content window.

At the information display step, if the user is performing some other works at a point when the information is displayed, the information display window may be displayed below all working windows to prevent hindrance to the some other works.

The information content window may be moved to uppermost position of working windows by clicking on a menu flickering on a lower end part of the screen of the user's computer so that contents of the information content window can be viewed.

At the information display step, the information list window may be formed of a title display region, a menu display region in which configuration can be performed, an information provider selection region, and an information list display region.

The information provider selection region may display the information providers from which the reception of information is allowed, and the configuration may be performed so that, when the user clicks on a desired information provider, the information list display region displays a list of previous information, with information, if a week or a predetermined period has elapsed since the information had been received, being automatically deleted.

When the user clicks on a title of desired information in the information list of the information list display region, an information content window corresponding to the title may be displayed on the screen of the user's computer while being located above all the working windows.

The method may additionally provide at least one of a service of storing information about a visited website by the client module when the user having a computer with installed client module visits the website of a specific information provider using a web browser and display information relating to the visited website through a separate window when running of the web browser is terminated or at some other time, a service of providing related product comparison information through a separate window while searching for a product in response to selection of the user, and a service of providing product information related to an event, such as gift presentation or a discount sale, through a product search window.

The method may further include the steps of the client module requesting reconfirmation of the deletion of the client module from the user when the user requests deletion of the client module, and transmitting information about the deletion of the client module, together with a unique number held by the client module, to the main service system when the user makes the reconfirmation of the deletion of the client module; the main service system deleting all pre-user information stored in a per-user information reception allowance DB and a per-user advertisement clicking pattern DB, and the like; and deleting the client module after deleting all data related to a list of information providers, a configuration parameters, environment variables, a list of previous information and contents of previous information stored in a data storage of the user's computer.

The operator of the main service system may manage and operate the variety of information and data, which are received from the user, the advertisers, the content information providers and the corporation information providers, through the main service system, the user may receive and view both the content information and the advertisements, which are transmitted from the selected information providers, without payment of fees, the content information providers may provide the content information, such as news, stock information, woman information and tour information, to the user through the main service system, and receives part of profits, which are obtained from the advertisers of the advertisements provided to the user, together with the content information, from the operator of the main service system, and the corporation information providers may pay annual fees or transmission fees depending on the amount of information to the operator of the main service system in payment for no provision of advertisements to the user when providing the corporation information to the user through the main service system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram showing a method of providing information, which is transmitted from selected content/corporation information providers having registered as members, to a user in real time;

FIG. 2 is a flowchart showing processes of installing a client module in a user's computer by one click and selecting an information provider in the method of the present invention;

FIG. 3 is a flowchart showing a process of displaying information, which is transmitted from the information provider selected by the user, on the screen of the user's computer in the method of the present invention;

FIG. 4 is a diagram showing a process of the content and corporation information providers registering with the main service system in the method of the present invention;

FIG. 5 is a view showing a process of first installing the client module and the list of the information providers, which are selected by the user, in the user's computer in the method of the present invention;

FIGS. 6a and 6b are diagrams showing a process of adding an information provider by a visit to a website or the clicking of a banner advertisement;

FIG. 7 is a diagram showing a process of changing an information reception allowance list through configuration in the method of the present invention;

FIG. 8 is a configuration diagram showing a process of transmitting the information of an information provider and an advertiser to the user's computer around the main service system in the method of the present invention;

FIGS. 9a, 9b and 9c are diagrams showing a process of displaying information, which is provided by the information provider, on the screen of the user's computer in the method of the present invention;

FIG. 10 is a diagram showing a process of providing the user with a specific advertisement, which is selected by the information selection and advertisement clicking of the user and is suitable for the user, in the method of the present invention;

FIGS. 11a, 11ba and 11c are diagrams showing a process of showing information, which is related to websites visited by the user, on a separate window in the method of the present invention;

FIG. 12 is a diagram showing a process of deleting the client module installed in the user's computer in the method of the present invention; and

FIG. 13 is a diagram showing the roles and authorities of the user, the operator of the main service system, the advertiser and the content and corporation information providers, and the distribution of profits in the method of the present invention.

### DESCRIPTION OF THE PREFERRED EMBODIMENTS

Reference should now be made to the drawings, in which the same reference numerals are used throughout the different drawings to designate the same or similar components.

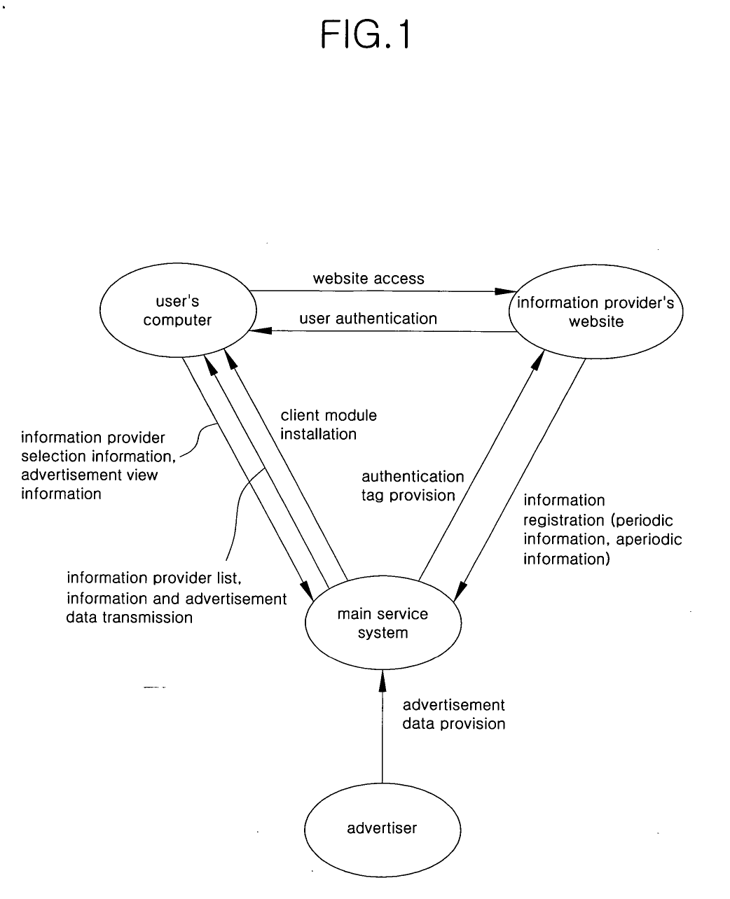

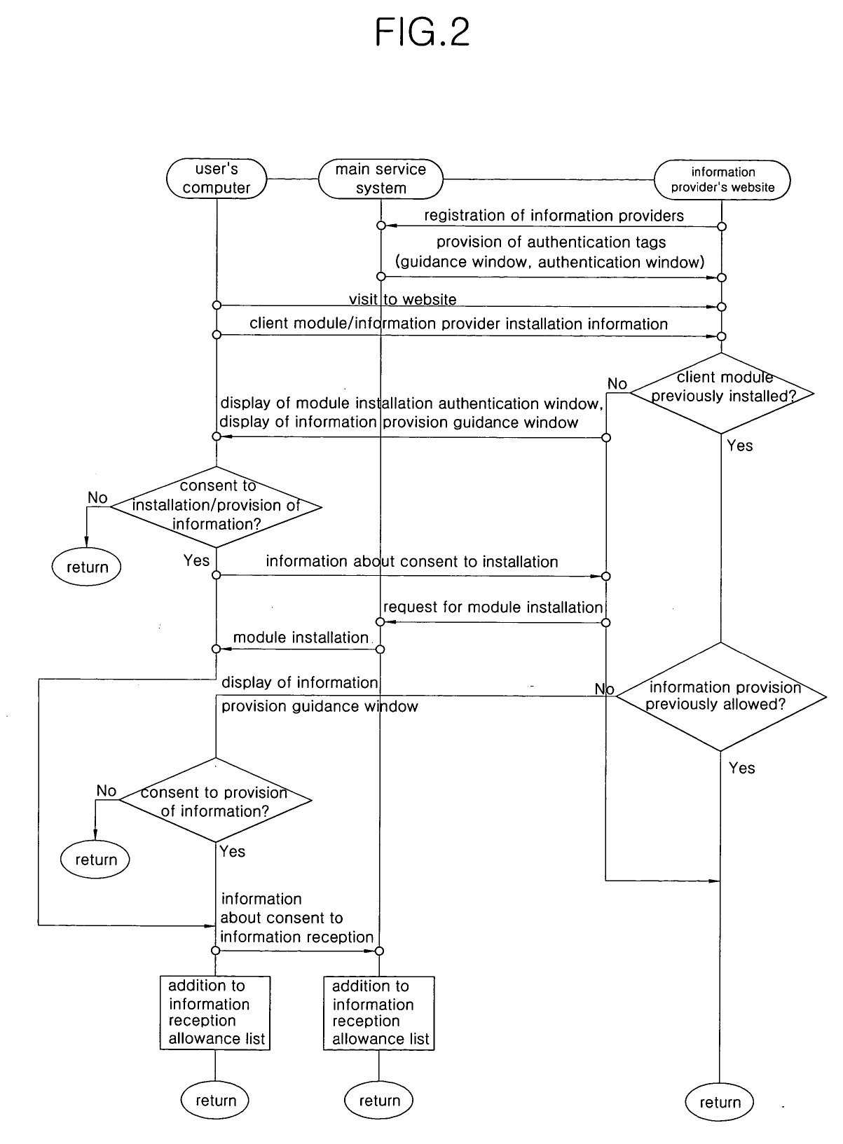

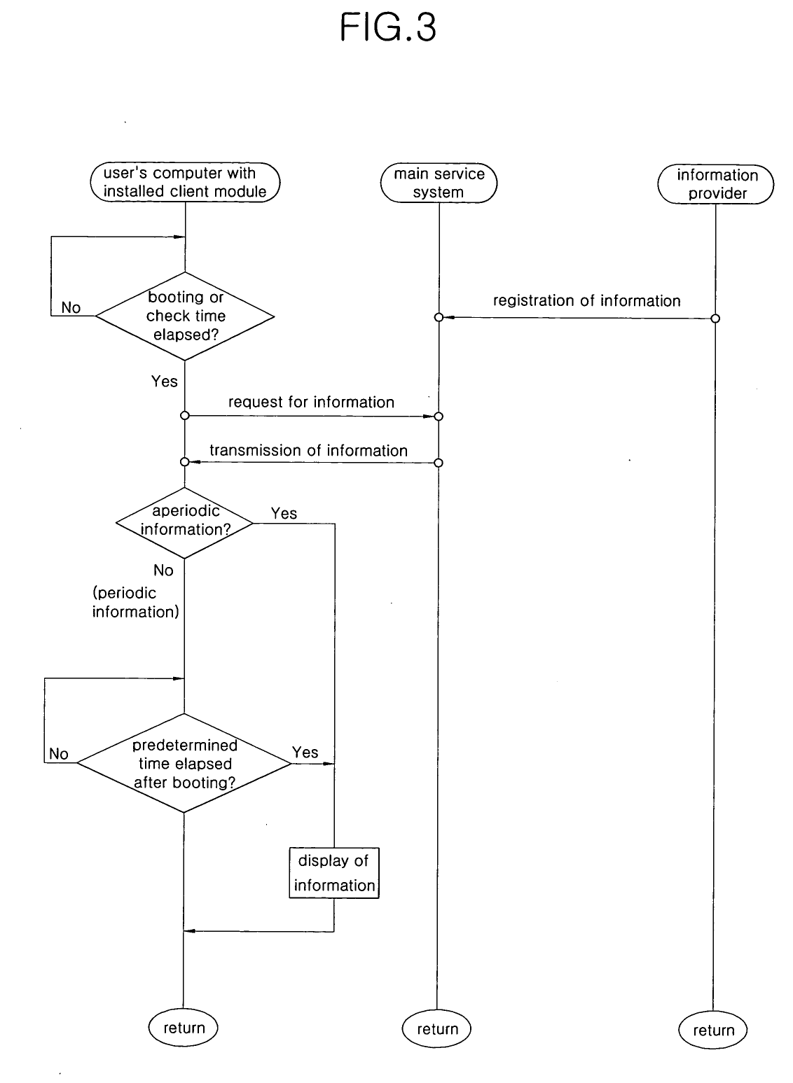

FIG. 1 is a configuration diagram showing a method of providing information, which is transmitted from selected content/corporation information providers having registered as members, to a user in real time. FIG. 2 is a flowchart showing processes of installing a client module in a user's computer by one click and selecting an information provider in the method of the present invention. FIG. 3 is a flowchart showing a process of displaying information, which is transmitted from the information provider selected by the user, on the screen of the user's computer in the method of the present invention.

As shown in FIGS. 1 to 3, in the method of the present invention, when a user's computer accesses the website of an information provider via the Internet that is one of various information networks, the website of the information provider displays a guidance window related to the provision of information and an authentication window related to installation of a client module, which are provided by a main service system, to perform user authentication. In this case, when the client module has been already installed in the user's computer, the authentication window is not displayed on the web screen, but only the guidance window relating to information provision is displayed on the web screen.

When the user consents to the information provision of the information provider through the authentication window and the guidance window, the main service system transmits the client module to the user's computer to which an authentication tag is transmitted, so that the client module is installed in the user's computer, after functional conjunction has been achieved by a web page constituting a part of the website of the information provider.

The main service system assigns a unique serial number to the user's computer at the same time that the client module is installed in the user's computer. Additionally, the main service system adds the information provider to the information provider list of the main service system and, simultaneously, sets the reception of information from the information provider to be allowed.

When the client module is installed in the user's computer, only the guidance window relating to information provision is displayed on the web screen of the user's computer. If the user consents to the conditions presented by the guidance window, the information provider is added to the information provider list of the client module and, simultaneously, the information provider is set to the allowance of information reception.

Meanwhile, information provided to the user is manually or automatically transmitted to the main service system from the website of each information provider, and stored in the main service system, which prepares the information to be transmitted to the user's computer.

The information stored in the main service system may be classified into periodic information that is provided to the user at regular intervals, such as headline news, and aperiodic information that is provided at irregular intervals, such as corporation information. The periodic information is provided to each user once or several times a day, for example, at the time when the user's computer is turned on and at regular intervals (e.g., six hours, and eight hours) thereafter. The irregular information can be provided only when new information exists.

Advertisements, which will be provided to the user, together with the information, are provided by advertisers, transmitted to the main service system, and stored in the main service system, which makes the advertisements ready to be able to be transmitted to the user's computer. The points when the user's computer installed with the client module receives the various information and advertisement data of information providers from the main service system may be different according to the types of information, such as periodic information and aperiodic information. For example, the user's computer receives the information and the advertisement data at the time when the user's computer is turned on and at regular intervals (30 minutes, one hour, six hours or eight hours) thereafter.

The intervals at which aperiodic information is detected are preferably set to shorter periods so that the point when the aperiodic information is provided to the client module comes close to the time when the aperiodic information is registered in the main service system.

The client module requests the transmission of information and advertisement data in conformity with a list of changed information providers and a list of current information reception allowance from the main service system. Thereafter, the client module compares the information and the advertisement data with the information and advertisement data stored in the user's computer, and receives the list of information providers, the information and the advertisement data only when the difference therebetween exists.

The client module displays received information and advertisement data on the information content window of the screen of the user's computer. In this case, the information content window is made to be located below all working windows to prevent hindrance to the user's other works, and the user is notified of the reception of information by allowing a notice message, such as the message ‘information received’, to flicker on the status bar at the lower end portion of the screen.

At that time, an advertisement view information relating to the fact that the user has viewed an advertisement, together with corresponding information, or has clicked on the advertisement is collected by the client module, and is transmitted to the main service system.

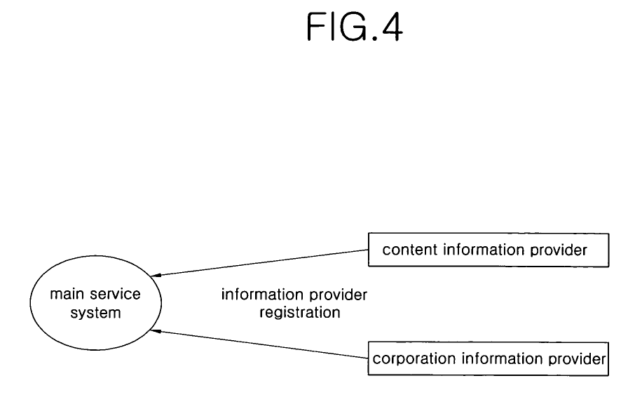

FIG. 4 is a diagram showing a process of content and corporation information providers registering with the main service system as members in the method of the present invention.

As shown in FIG. 4, before an authentication tag is set in the website of an information provider, such as a content or corporation information provider, to install the client module, the information provider must have registered with the main service system as an information provider. In this case, the information provider must be classified into a content information provider or a corporation information provider. A list of content information providers is provided to all users' computers in which client modules are installed.

To register as a corporation information provider, fees must be paid to the main service system in the form of annual fees. Depending upon the fees paid, the number of times the information will be transmitted to the user's computer may be limited. If the number of times information is transmitted to the user's computer exceed the limited number of times corresponding to annual fees, the information can be further transmitted only when additional fees are paid.

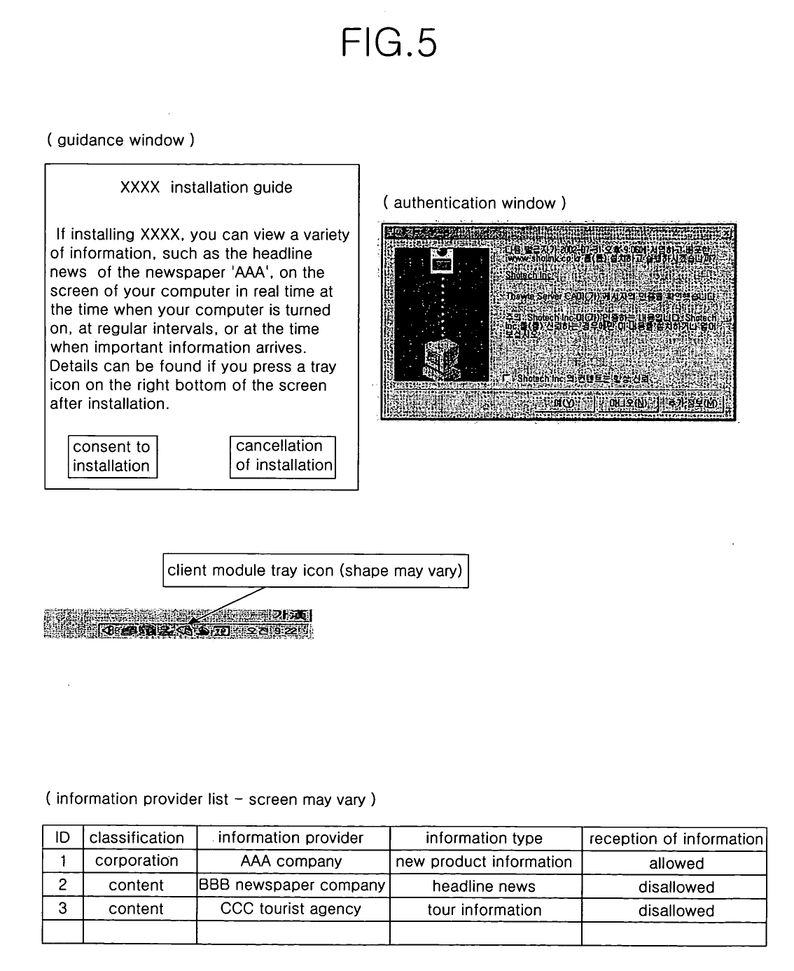

FIG. 5 is a view showing a process of first installing the client module and the list of the information providers, which are selected by the user, in the user's computer in the method of the present invention.

As shown in FIG. 5, when the user having the user's computer accesses the website of an information provider (for example, ‘AAA’ newspaper company) using a web browser, the authentication window, together with the guidance window, is displayed by the authentication tag. If the user clicks on ‘YES’ on the authentication window after clicking on ‘consent to installation’, the client module is installed in the user's computer and a tray icon indicating the installation of the client module is displayed on the right bottom of the screen of the user's computer.

The client module is installed in the user's computer by user's selection, and simultaneously, the ID of a corresponding information provider, the discrimination between content information and corporation information, the name of the information provider, the name of provided information, and whether information reception is allowed or not are stored in the data storage of the user's computer as the first item of the information provider list.

Furthermore, the user's computer receives an existing content information provider list from the main service system, and the existing content information provider list is additionally stored in the data storage of the user's computer. Since the information provider list is first transmitted and the reception of information from the information providers of the list are not set to be allowed, the reception of information is displayed to be disallowed.

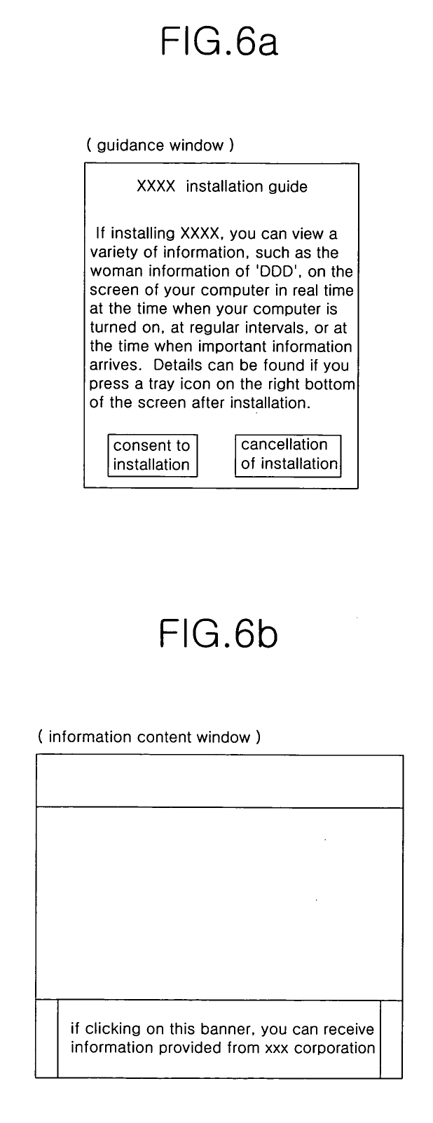

FIGS. 6a and 6b are views showing a process of installing an information provider additionally through a visit to a website or a click on a banner advertisement, in the method of providing information, which is transmitted from selected content and/or corporation information providers having registered as members, to the user in real time.

As shown in FIGS. 6a and 6b, when the user visits the website of the information provider, who is not contained in the information provider list or who is not allowed to receive information though contained in the information provider list, after the client module has been installed in the user's computer, the authentication window relating to the installation of the client module is not displayed and only the guidance window is displayed by the authentication tag.

When the user clicks on ‘consent to installation’ in the guidance window, a corresponding provider is added to the information provider list of the user's computer and, simultaneously, the reception of information from the information provider is set to be ‘allowed’ if the information provider is not included in the information provider list, or the reception of information is set to be ‘allowed’ if the information provider is included in the information provider list.

Another method of adding an information provider to the information provider list is to click on a banner advertisement displayed, together with information, in the information content window, as shown in FIG. 6b. The banner advertisement displayed, together with the information, contains the sentence that informs the user of the additional installing of an information provider. When the user clicks on the sentence, the information provider is added to the information provider list, and simultaneously, the reception of information is set to ‘allowed’, so that the information provider, which the user wants, can be simply added to the information provider list by one click.

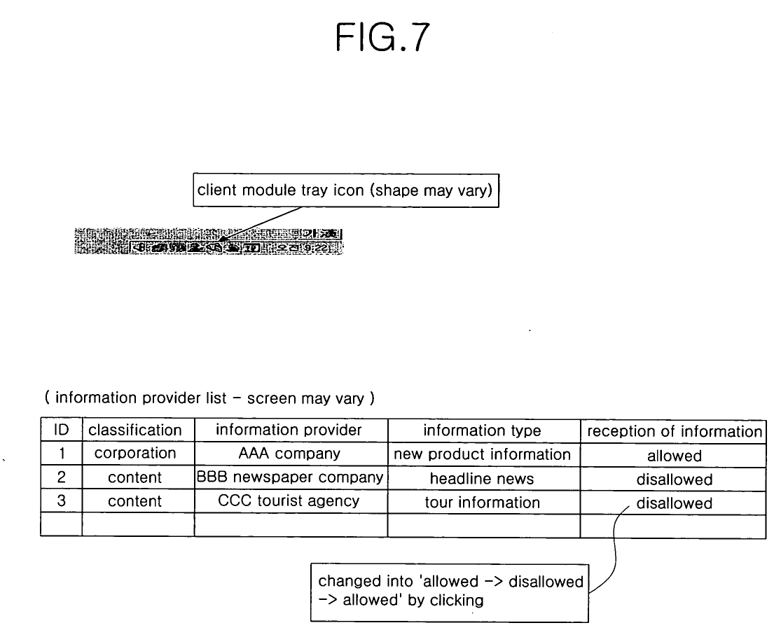

FIG. 7 is a diagram showing a process of changing an information reception allowance list through configuration in the method of the present invention. When the user clicks on the display tray icon of the client module, configuration can be performed and the information provider list is displayed as part of configuration.

The user can add and delete an information provider to and from the information reception allowance list on an information provider list window, which can be simply performed by clicking on a column indicating whether the reception of information is allowed or not. When a mouse is clicked, the indication whether the reception of information is allowed or not is changed from ‘disallowed’ to ‘allowed’, or from ‘allowed’ to ‘disallowed’.

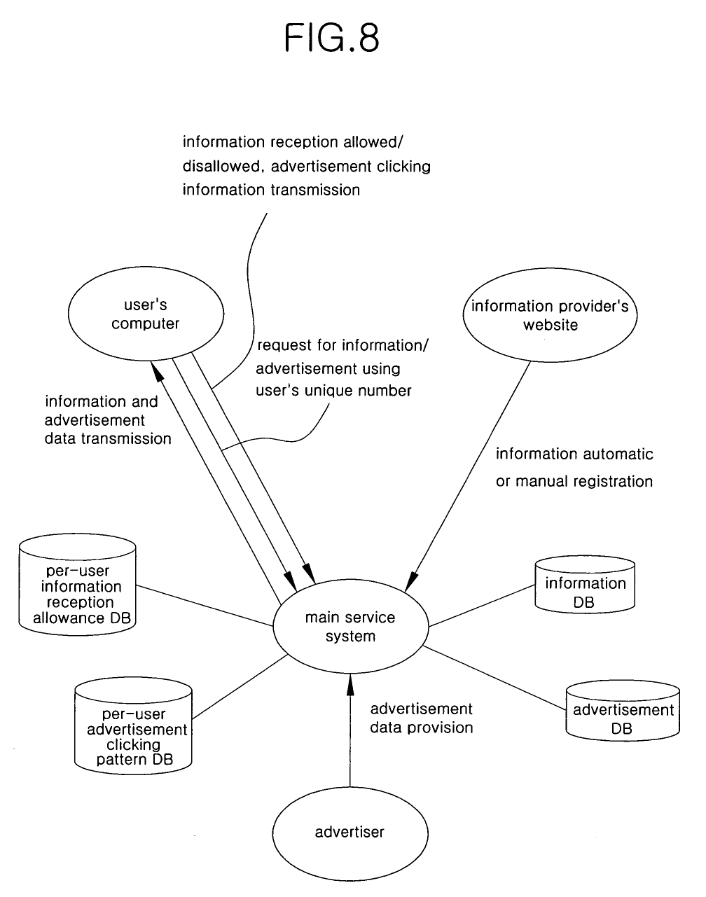

FIG. 8 is a configuration diagram showing a process of transmitting the information of an information provider and an advertiser to the user's computer around the main service system in the method of the present invention.

As shown in FIG. 8, whenever the user sets the reception of information from a specific information provider to be ‘allowed’ or ‘disallowed’, the information of the setting is transmitted to the main service system, and stored in a per-user information reception allowance DataBase (DB). Furthermore, information about advertisement reference and information clicking is transmitted to the main service system, is stored in a per-user advertisement clicking pattern DB, and will be used as material for target advertisement later.

The website of a registered information provider or the operator of the website can make the information provider be registered with the main service system automatically, or by manual input. The information of the registered information provider is stored in the information DB of the main service system, so that the information transmitted from the information provider can be transmitted to the user's computer in response to the request of the user's computer.

Furthermore, advertisement-related data, such as an advertisement image file, an advertisement date and the number of times of advertisement, is separately provided from an advertiser, and is stored in the advertisement DB of the main service system. The user's computer ascertains where new information relating to the user's computer exists by transmitting a user's unique number to the main service system whenever being turned on or at regular intervals and receives the new information together with advertisement data.

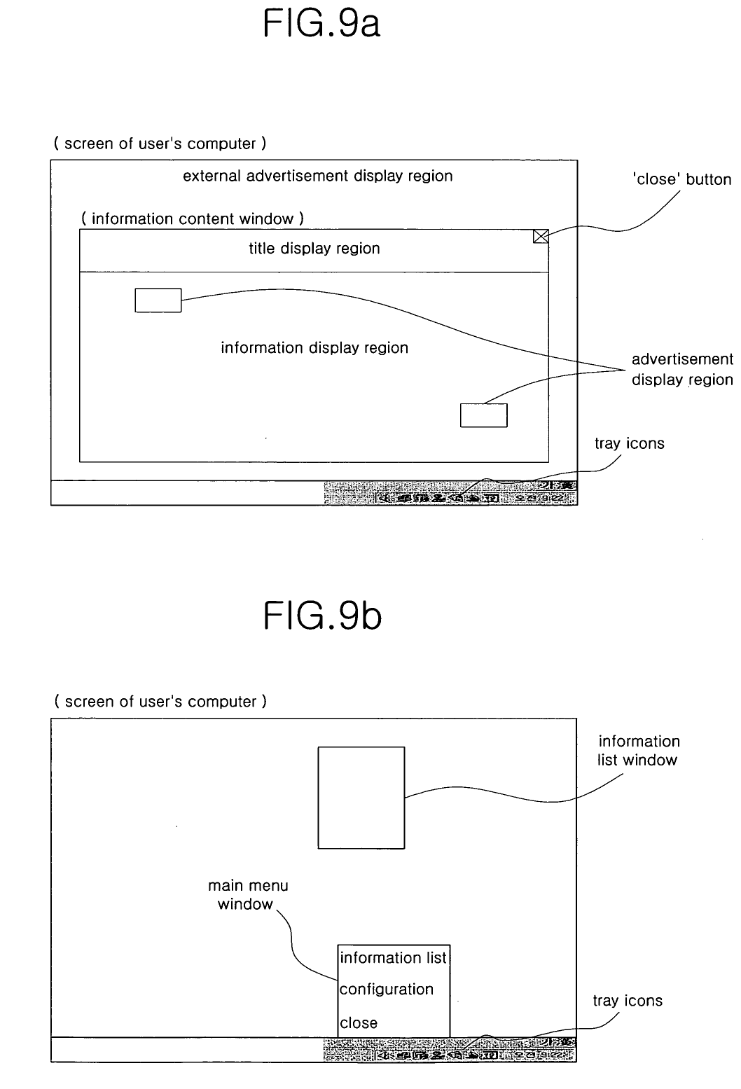

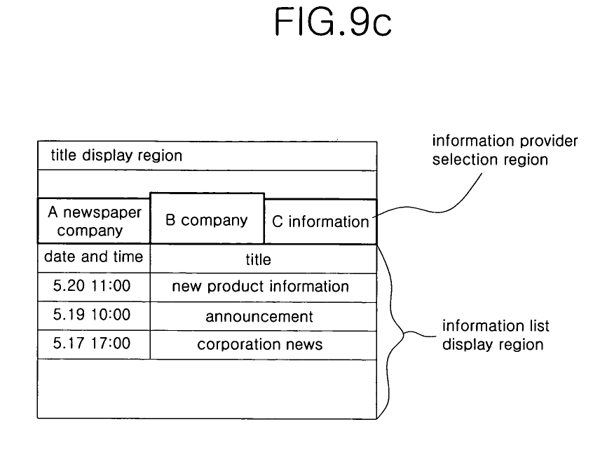

FIGS. 9a, 9b and 9c are diagrams showing a process of displaying information, which is provided by the information provider, on the screen of the user's computer in the method of the present invention.

When the client module of the user's computer receives new information from the main service system, the information content window is displayed on the screen of the user's computer per information provider, as shown in FIG. 9a. The above-described information content window is divided into a title display region displaying the title of information, one or more advertisement display regions displaying advertisement images, and an information display region displaying the contents of information. An external advertisement display region, which is capable of displaying a special advertisement, such as the image of a moving automobile, is located outside the information content window.

In that case, if the user is performing other works at the time when the information is displayed on the screen of the user's computer, the information content window is indicated below all the working windows to prevent hindrance to user's other works. This information content window is fully displayed after the user has closed all working windows. Of course, the contents of the information content window may be ascertained without the closing of all the working windows. That is, the information content window is located over all the working windows by clicking on a menu flickering on a lower end part of the screen of the user's computer, and the contents of the information content window are ascertained. Furthermore, the information content window can be closed by clicking on a ‘close’ button that is located at the right top of the information content window.

Additionally, the user can ascertain previous information on the user's computer, which is described with reference to FIGS. 9b and 9c.

When the user clicks a left mouse button on a tray icon displayed on the screen of the user's computer, as shown in FIG. 9b, an information list window is displayed on the right bottom of the screen of the user's computer. Alternately, when the user clicks a right mouse button on the tray icon of the screen of the user's computer, a main menu window is displayed on the screen of the user's computer. When the user selects an information list item from the main menu window, the information list window is displayed on the right bottom of the screen of the user's computer in the same manner as described above.

The information content list window displayed on the screen of the user's computer as described above, as shown in FIG. 9c, is divided into a title display region, an information provider selection region and an information list display region. Of these regions, the information provider display region displays information providers from which the reception of information is allowed. When the user clicks on a desired one of the displayed information providers, a list of information received from the desired information provider is displayed on the information list display region.

Configuration may be made so that, when a week or specific period has elapsed after information was received by the user's computer, the information indicated by the list of information is automatically deleted by the client module and not displayed on the list of information any further.

When the user clicks on the title of desired information on the information list of the information list display region, a corresponding information content window is displayed on located over all working windows and is displayed on the screen of the user's computer.

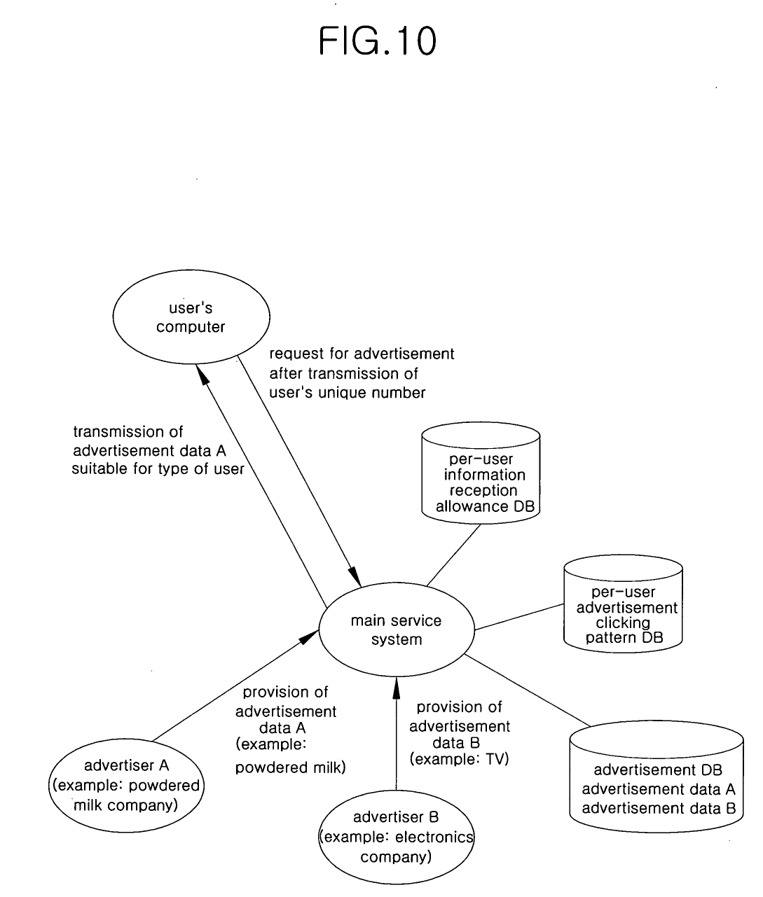

FIG. 10 is a diagram showing a process of providing the user with a specific advertisement, which is selected by the information selection and advertisement clicking of the user and is suitable for the user, in the method of the present invention.

As illustrated in FIG. 10, a plurality of information providers, such as content information providers and corporation information providers, e.g., a powdered milk company and an electronics company, have registered with the main service system, and target advertisement aiming for the minimizing of the avoidance of an advertisement by users and the increase of the efficiency of advertisement can be performed by analyzing the types of the users based on the patterns of information and advertisement clicking performed through the information content window of the user's computer.

That is, the type of the user can be analyzed based on a list of information providers from which the reception of information is set to be allowed. For example, when the user is receiving ‘woman information’, it can be known that the user is a woman. When the user is receiving ‘nursing information’, the user can be classified as a married woman that has delivered a child or is preparing for delivery.

Similarly, the main service system can estimate the type of the user by analyzing the information of clicks on an existing advertisement that is performed by the user.

Consequently, the main service system may transmit different types of advertisements or information to users depending on the types of users, or transmit advertisements or information, which has been edited to fit the types of users, to the users even though the advertisements or information are of the same type.

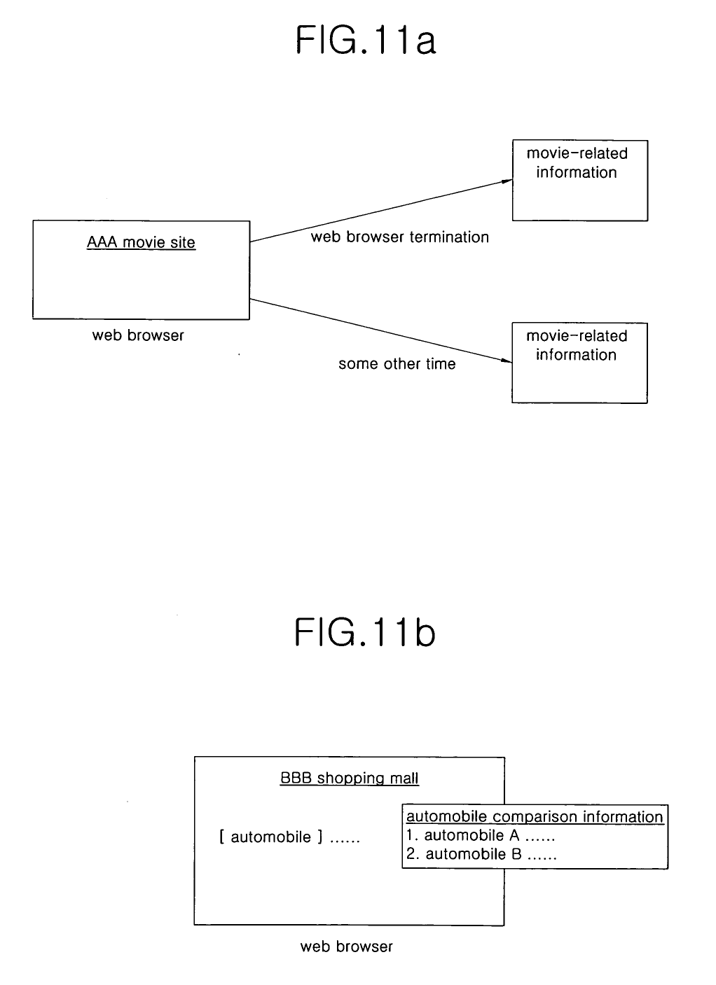

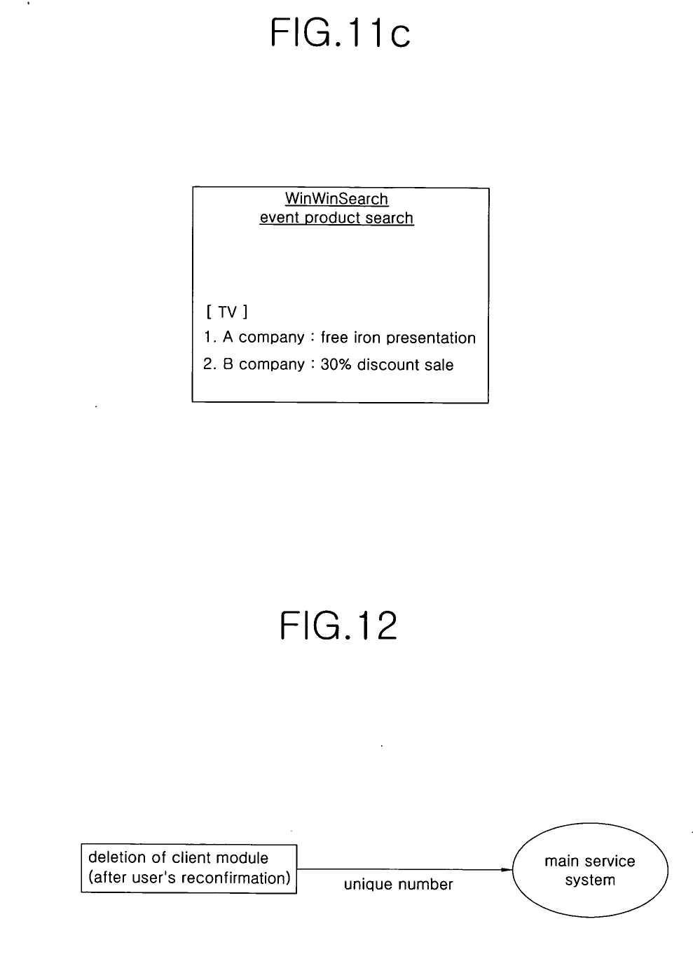

FIGS. 11a, 11ba and 11c are diagrams showing a process of showing information, which is related to websites visited by the user, on a separate window in the method of the present invention.

As illustrated in FIGS. 11a, 11b and 11c, when the user of the user's computer, in which the client module is installed, visits the website of a specific information provider using a web browser, the client module may store the information of the visiting, and shows information, which relates to the website of the specific visited by the user, through a separate window at the time when the running of the web browser is terminated or at some other time.

For example, as illustrated in FIG. 11a, when the user visits a movie site, information relating to movie is shown on the screen of the user's computer through a separate window at the time when the running of the web browser is terminated or at some other time.

Furthermore, as illustrated in FIG. 11b, while the user is searching for a product, information relating to the comparison of associated products may be provided to the user through a separate window according to the selection of the user. With this, a variety of product information can be provided to users, and increased opportunities for advertisement can be provided to advertisers.

As illustrated in FIG. 11c, only product information relating to events, such as gift presentation or discount sales, may be provided to the user through a separate window according to the selection of the user. The method is beneficial both to users and to advertisers.

FIG. 12 is a diagram showing a process of deleting the client module installed in the user's computer in the method of the present invention.

As illustrated in FIG. 12, the user can delete the client module using a program deleting program that is provided by the user's computer.

In that case, the client module requests the user to reconfirm the deletion of the client module. If the reconfirmation is performed, the client module transmits information about the deletion of the client module, together with a unique ID held by the client module, to the main service system.

The main service system having received the information about the deletion of the client module delete all the information relating to the user, which is stored per user in the per-user information reception allowance DB and the per-user advertisement clicking pattern DB.

Furthermore, after the client module has deleted all the data relating to the list of information providers, configuration parameters, previous lists of information and the contents of information, the client module is deleted at the final state thereof.

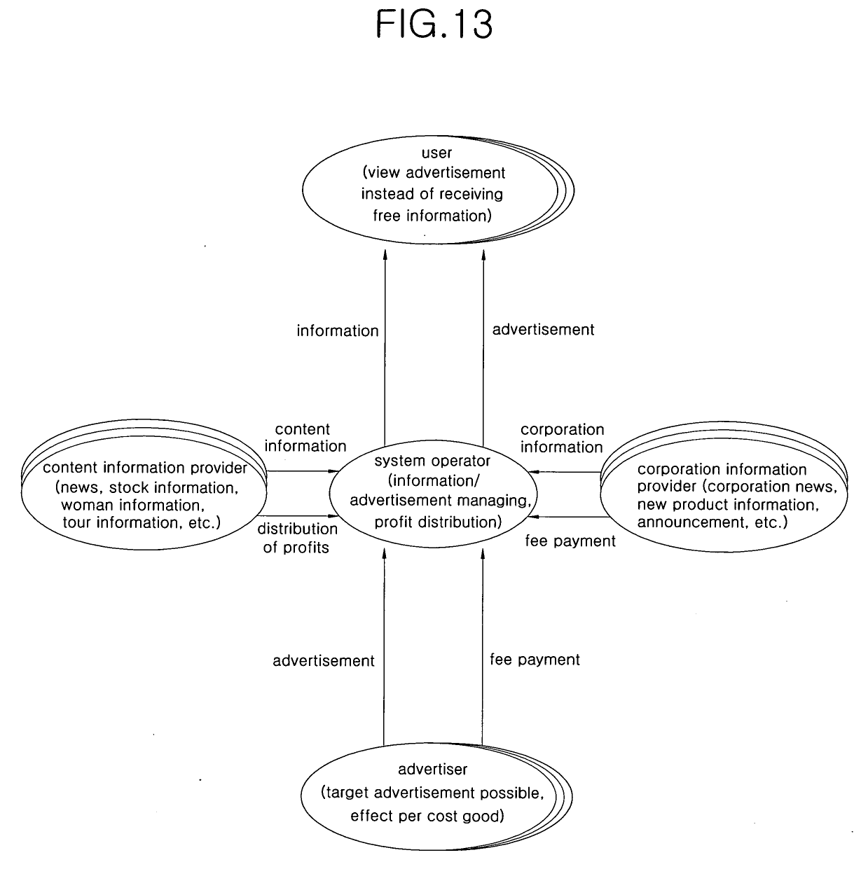

FIG. 13 is a diagram showing the roles and authorities of the user, the operator of the main service system, the advertiser and the content and corporation information providers, and the distribution of profits in the method of the present invention.

As illustrated in FIG. 13, in the present invention, the operator of the main service system takes charge of managing and operating a variety of information and data, which is received from the user, the advertiser and the content and corporation information providers, through the main service system, and functions as a linkage between the related parties.

That is, the user can receive necessary information from the information providers, which has been selected by the user, without paying fees, but the user must view advertisements that are provided together with content information.

The content information providers provide content information, such as news, stock information, woman information and tour information, to the user through the main service system, and receives part of profits, which are obtained from the advertisers of advertisements provided to the user, together with the content information, from the operator of the main service system.

The corporation information providers provide corporation information to the user through the main service system. The corporation information providers must pay annual fees or transmission fees depending on the amounts of information to the operator of the main service system. Accordingly, the advertisers cannot transmit advertisements, together with the corporation information, but can transmit advertisements, together with the content information, so that the advertisers must pay advertisement fees to the operator of the main service system.

In particular, in the case of performing target advertisement according to the types of users, the types of users must be analyzed and high advertising efficiency can be expected, so that advertisers must pay fees higher than those of general advertisement.

As described above, in accordance with the present invention, the client module, which allows the user to receive a variety of necessary information from content and corporation information providers, can be easily installed in the user's computer by one click, so that the user can be provided with the necessary information by the desired information providers, which are selected by the user from a plurality of content and corporation information providers, without exposing the personal information of the user, such as a residence registration number, an e-mail address, a phone number, an address and an facsimile number.

To display information on the screen of the user's computer, when new information arrives, the new information is automatically indicated below all working windows, so that information required by the user can be provided to the user without the inconveniences of running a web browser and visiting the websites of the information providers and hindrance to user's other works.

Furthermore, the time when a variety of information is provided to the user through the screen of the user's computer can be limited to the time, such as the time when the user's computer is turned on, the time at regular intervals during the turning on of the user's computer or the time whenever new information arrives, so that the user does not need to receive unnecessary information and obtains information at desired time.

Furthermore, the present invention classifies information providers into content information providers and corporation information providers, so that a way of information provision can be provided to corporations and the operation of the service system does not need to depend on the incomes of advertisement, thus obtaining various profit sources.

The present invention allows information to be provided to only the users who want the information, so that the service system can be easily linked to a plurality of users without any complaints, and spam mails, which are indiscriminately transmitted to the users who do not want the mails, can be reduced.

Furthermore, in accordance with the present invention, the features of websites, the patterns of information selection of users and the patterns of information clicking of users are collected as information for target advertisement, so that advertisement can be made for users requiring the advertisement without inconveniences of inputting personal information or responding to questionnaires, thus improving the efficiency of advertisement and increasing the profits of the operator of the main service system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing information, which is transmitted from selected content and/or corporation information providers having registered as members, to a user in real time, comprising:
the information provider registration step of the content and/or corporation information providers registering with a main service system as information providers;
the client module installation step of the user visiting websites of some of the information providers having registered as the information providers, installing a client module in a user's computer through the main service system, determining whether reception of information from the information provider is allowed or not, and transmitting and storing information about the user's computer and whether reception of information from the information provider is allowed or not to and in the main service system;
the information transmission step of receiving information from the content and/or corporation information providers having registered as the information providers, storing the information, which is transmitted from the content and/or corporation information providers, in the main service system, and transmitting only information, which is transmitted from information providers from which reception of information is allowed, to the user's computer at a point selected by the user; and
the information display step of displaying information, which is transmitted from the main service system, on a screen of the user's computer.

2. The method according to claim 1, wherein the information providers of the information provider registration step include content information providers capable of providing content information, such as news, stock information, woman information and tour information, and corporation information providers capable of providing corporation information, such as corporation news, official announcements and new product information.

3. The method according to claim 1, wherein, at the information provider registration step, in the website of the information provider, authentication tags for the installation of the client module are added to a guidance window and an authentication window.

4. The method according to claim 1, wherein, at the information provider registration step, if the corporation information providers pay registration fees, such as annual fees, the main service system determines a number of time of transmission of information based on the paid fees, and transmits additional information only when additional fees are paid.

5. The method according to claim 1, wherein, at the client module installation step, when the user's computer accesses a website of one of the information providers having registered as the information providers, the information provider displays a guidance window that includes a description of a client module capable of allowing the user to receive information in real time without leakage of personal information, and an authentication window that allows the user to perform authentication related to installation of the client module.

6. The method according to claim 1, wherein, at the client module installation step, if the user consents to the installation of the client module after viewing the guidance window and the authentication window, the client module is installed in the user's computer by the main service system, and an icon indicating completion of the installation of the client module is displayed on a lower part of the screen of the user's computer.

7. The method according to claim 1, wherein the client module installation step further comprises the step of, after the client module has been installed in the user's computer, additionally select an information provider, from which the user can receive information, by visiting a website of another information provider having registered as the information providers or clicking on a banner advertisement displayed on the screen of the user's computer.

8. The method according to claim 7, wherein, at the additional information provider selection step, if the user consents to the additional selection after viewing the guidance window, the information provider is added to the information provider list of the user's computer, reception of information from the information provider is set to be allowed, and related information is transmitted to the main service system.

9. The method according to claim 7, wherein, at the additional information provider selection step, if the user selects the information provider from which the user can receive information by clicking on an existing icon, the information provider is added to the information provider list of the user's computer, the reception of information from the information provider is set to be allowed, and related information is transmitted to the main service system.

10. The method according to claim 7, wherein, at the additional information provider selection step, the user receives a list of all the information providers having registered as the information providers from the main service system, selects an information provider, which provides information desired by the user, from the list of the all the information providers, and removes an information provider from the list of the all the information providers.

11. The method according to claim 7, wherein, at the additional information provider selection step, if the user selects the information provider by clicking on a banner advertisement of an information display window that displays corporation information including a clause ‘if clicking on this banner, you additionally receives information’, the information provider is added to the information provider list of the user's computer, the reception of information from the information provider is set to be allowed, and related information is transmitted to the main service system.

12. The method according to claim 1, wherein the client module installation step further comprises the step of performing configuration of the client module by the user's clicking on a tray icon of the client module, and the user's adding/deleting an information provider to/from the reception allowance list on the information provider list window that is displayed during the configuration.

13. The method according to any of claims 1, 7 and 12, wherein, whenever the reception of information from an information provider is set to be allowed or disallowed, related information is transmitted to the main service system, and the transmitted information is stored in a per-user information reception allowance DataBase (DB).

14. The method according to claim 1, wherein, at the information transmission step, advertisement views and clicking information performed by the user on the user's computer are collected, transmitted to the main service system, and stored in a per-user advertisement clicking pattern DB.

15. The method according to claim 1, wherein, at the information transmission step, information, which will be transmitted by the user, is classified as periodic or aperiodic information, registered manually or automatically in the main service system, and stored in an information DB of the main service system to be prepared for provision to the user in response to a user's request.

16. The method according to claim 1, wherein, at the information transmission step, advertisement-related data, including advertisement image files, advertisement dates, and numbers of advertisement, are provided from the advertisers respectively, and stored in an advertisement DB of the main service system.

17. The method according to claim 1, wherein, at the information transmission step, the user's computer transmits a user's unique number to the main service system at a time when the user's computer is turned on or at regular intervals so that it can be determined whether new information exists and the user's computer can receive the new information, together with an advertisement.

18. The method according to claim 1, wherein the information transmission step further comprises the step of the main service system determining a type of the user by analyzing a list of information providers, from which reception of information is allowed, and/or information about clicking of existing advertisements, and transmitting an appropriate type of advertisement or an advertisement modified to fit the type of user to the user according to the type of user.

19. The method according to claim 1, wherein, at the information display step, when the client module of the user's computer receives new information from the main service system, the client module displays an information content window on the screen of the user's computer for each of the information providers.

20. The method according to claim 19, wherein, at the information display step, the information content window is formed of a title display region displaying a title of information, an information display region displaying contents of information, and an advertisement display region displaying an advertisement image, and an external advertisement display region, which is capable of displaying a special advertisement, such as an image of a moving automobile, is located outside the information content window.

21. The method according to claim 1, wherein, at the information display step, if the user is performing some other works at the point when the information is displayed, the information display window is indicated below all working windows to prevent hindrance to the some other works.

22. The method according to claim 21, wherein the information content window is moved to uppermost position of working windows by clicking on a menu flickering on a lower end part of the screen of the user's computer so that contents of the information content window can be viewed.

23. The method according to claim 1, wherein, at the information display step, the information list window is formed of a title display region, a menu display region in which configuration can be performed, an information provider selection region, and an information list display region.

24. The method according to claim 23, wherein the information provider selection region displays the information providers from which the reception of information is allowed, and the configuration can be performed so that, when the user clicks on a desired information provider, the information list display region displays a list of previous information, with information, if a week or a predetermined period has elapsed since the information had been received, being automatically deleted.

25. The method according to claim 24, wherein, when the user clicks on a title of desired information in the information list of the information list display region, an information content window corresponding to the title is displayed on the screen of the user's computer while being located above all the working windows.

26. The method according to claim 1, wherein the method additionally provides at least one of a service of storing information about a visited website when the user visits the website of a specific information provider using a web browser and displaying information relating to the visited website through a separate window at the time when running of the web browser is terminated or at some other time, a service of providing related product comparison information through a separate window while searching for a product in response to selection of the user, and a service of providing product information related to an event, such as gift presentation or a discount sale, through a product search window.

27. The method according to claim 1, further comprising the steps of:
the client module requesting reconfirmation of the deletion of the client module from the user when the user requests deletion of the client module, and transmitting information about the deletion of the client module, together with a unique number held by the client module, to the main service system when the user makes the reconfirmation of the deletion of the client module;
the main service system deleting all per-user information stored in a per-user information reception allowance DB and a per-user advertisement clicking pattern DB, and the like; and
deleting the client module after deleting all data related to a list of information providers, a configuration parameters, environment variables, a list of previous information and contents of previous information stored in a data storage of the user's computer.

28. The method according to claim 1, wherein:
the operator of the main service system manages and operates the variety of information and data, which are received from the user, the advertisers, the content information providers and the corporation information providers, through the main service system;
the user receives and views both the content information and the advertisements, which are transmitted from the selected information providers, without payment of fees;
the content information providers provide the content information, such as news, stock information, woman information and tour information, to the user through the main service system, and receives part of profits, which are obtained from the advertisers of the advertisements provided to the user, together with the content information, from the operator of the main service system; and
the corporation information providers pay annual fees or transmission fees depending on the amount of information to the operator of the main service system in payment for no provision of advertisements to the user when providing the corporation information to the user through the main service system.
